(19) United States
(12) Patent Application Publication
(10) Pub. No.: US 2023/0228082 A1
(43) Pub. Date: Jul. 20, 2023

(54) Glazed Curtain Wall Panel System

(71) Applicant: O'KEEFFE'S, INC., BRISBANE, CA (US)

(72) Inventor: William F O'Keefe, Brisbane, CA (US)

(73) Assignee: O'KEEFFE'S, INC., BRISBANE, CA (US)

(21) Appl. No.: 18/099,878

(22) Filed: Jan. 20, 2023

Related U.S. Application Data
(60) Provisional application No. 63/301,327, filed on Jan. 20, 2022.

(51) Int. Cl. E04B 1/94; E04B 2/88

(52) U.S. Cl. CPC E04B 1/942; E04B 2/88

(57) ABSTRACT

A panelized, versatile structurally glazed curtain wall system developed with a dual purpose as a unique system that will provide ease of installation in a curtain wall, and a fire rated version, that can be pre-fabricated in a factory and transported as a unit to the installation location. Both can be used alone or married together easily for seamless unbroken horizontal and vertical sight lines. Installation is improved and made more productive due to its prefabrication so that it is ready to install with little additional hardware. At least one embodiment utilizes only vertical building structure (and not horizontal building structure) for secure and effective installation, avoiding the need for accessing structure in ceilings and/or floors.

The disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCES TO RELATED APPLICATIONS

This application claims the benefit of U.S. provisional patent application Ser. No. 63/301,327 filed on Jan. 20, 2022, incorporated herein by reference.

### BACKGROUND

Conventional approaches for wall systems such as glazed curtain wall systems show a need for a system that provides ease of installation and flexibility of design in a panelized curtain wall that can provide more pleasing aesthetics, but that also can provide strength and fire protection.

### SUMMARY

Provided are a plurality of example embodiments, including, but not limited to, a panelized, versatile structurally glazed curtain wall system developed with a dual purpose. “S.W.S. SAFTI Architectural” is a unique system that will provide ease of installation in a curtain wall, and a fire rated version, “S.W.S. SAFTI Architectural F.R.” Both can be used alone or married together easily for seamless unbroken horizontal and vertical sight lines. Installation is improved and made more productive by a design that allows the device to be manufactured remotely in a factory as a unit, and then transported for installation at the desired location. At least one embodiment utilizes only vertical building structure for secure and effective installation, avoiding the need for accessing structure in ceilings and/or floors.

This provides a breakthrough product that provides architects, owners, and façade consultants with the greatest flexibility of design. All engineered with lower cost in mind through ease of installation and the largest fire-rated glazed areas available “S.W.S. SAFTI Architectural F.R.” provides panels that can be 130 inces high and 130 inches wide (130″×130″), typically not to exceed 72.2 Square feet, and even larger panel sizes for the non-rated areas, “S.W.S SAFTI Architectural.” These large, conventional “S.W.S. SAFTI Architectural” or “S.W.S. SAFTI Architectural F.R.” fire resistive ASTM E-119/NFPA 250/UL 263 wall panels, can be mixed together up to their maximum engineered size. All this with a pleasing, slim two-inch (2″) profile sight line. SAFTI FIRST anticipates this capability will be extremely popular with architects in allowing unmatched design flexibility with energy performance, decorative or security options, ballistic, blast, hurricane, etc. Both of these S.W.S. SAFTI Wall products will provide versatility, cost savings, and ease of installation with the additional option of fire ratings up to 2 hours.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, which are incorporated herein in their entirety.

FIG. 1 is a diagram showing a first embodiment of an example glass panel 10;

FIG. 2 is a diagram showing a second embodiment of an example glass panel;

FIG. 3 is a schematic diagram showing the head and top horizontal mullion detail of an example embodiment of a prefabricated curtain wall panel;

FIG. 4 is a schematic diagram showing the vertical mullion detail of the example embodiment of the prefabricated curtain wall panel;

FIG. 5 is a schematic diagram showing the still and bottom mullion detail of the example embodiment of the prefabricated curtain wall panel;

FIG. 6 is a schematic diagram showing the jamb detail of the example embodiment of the prefabricated curtain wall panel;

FIG. 7 is a diagram showing an example F-Bracket of the example embodiment of the prefabricated curtain wall panel;

FIG. 8 is a schematic diagram showing the sill anchor detail of the example embodiment of the prefabricated curtain wall panel; and

FIG. 9 is a diagram showing Spring Clip Detail of the example embodiment.

### DETAILED DESCRIPTION OF THE EXAMPLE EMBODIMENTS

Disclosed herein is one or more examples of a Glazed Curtain Wall Panel System that can be prefabricated in a factory, and transported to a desired location for installation in an existing or under construction building or other structure, such as in horizontal and vertical butt glazed/joint applications. This system provides a breakthrough product solution that provides architects, owners, and façade consultants with the greatest flexibility of design. All engineered with lower cost in mind through ease of installation and the largest fire-rated glazed areas available and rated “S.W.S. SAFTI Architectural F.R.” provides one hundred thirty inch high and eighty-inch wide (130″×80″) panels and even larger panel sizes for the non-rated areas, “S.W.S SAFTI Architectural.”

These large, conventional “S.W.S. SAFTI Architectural” or “S.W.S. SAFTI Architectural F.R.” fire resistive ASTM E-119/NFPA 251/UL 263 wall panels, can be mixed together up to their maximum engineered size. All this with a pleasing, slim two-inch (2″) profile sight line. SAFTI FIRST anticipates this capability will be extremely popular with architects in allowing unmatched design flexibility with energy performance, decorative or security options, ballistic, blast, hurricane, etc. Both of these S.W.S. SAFTI Wall products will provide versatility, cost savings, and ease of installation with the additional option of fire ratings up to 2 hours.

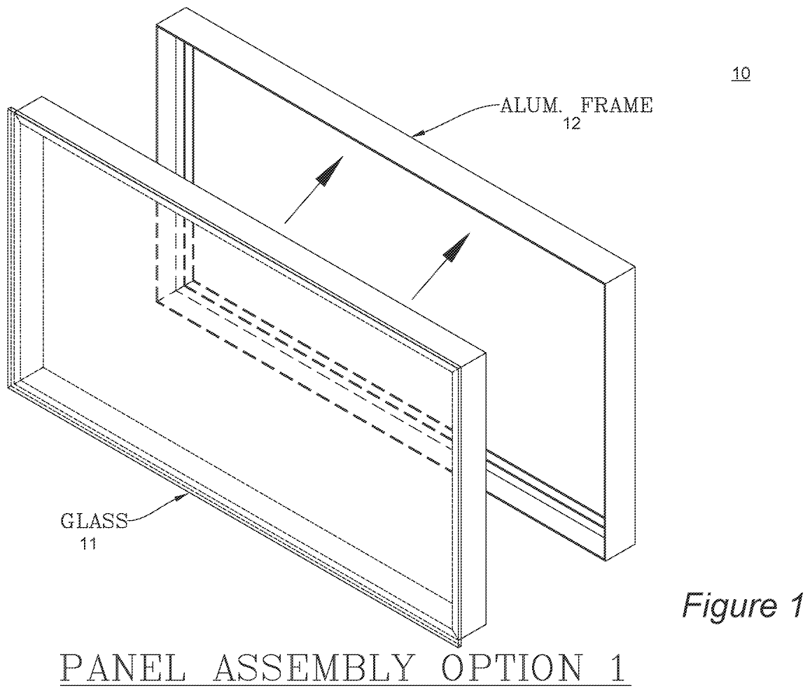

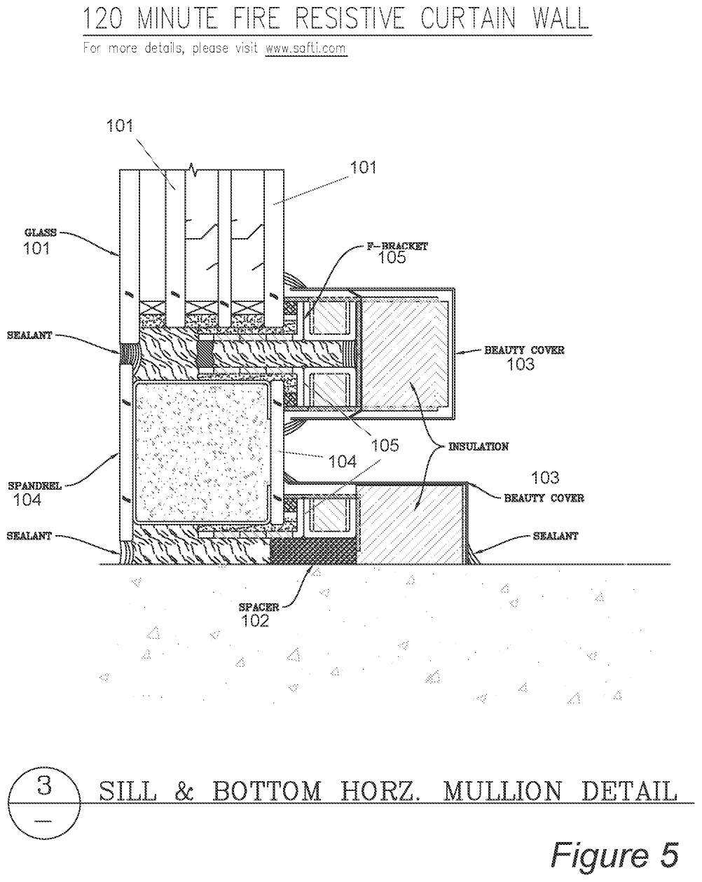

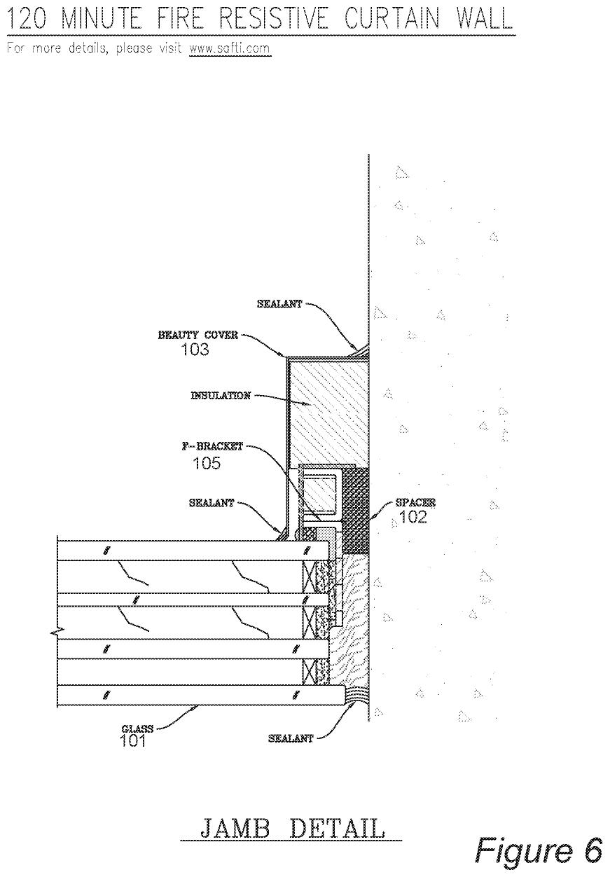

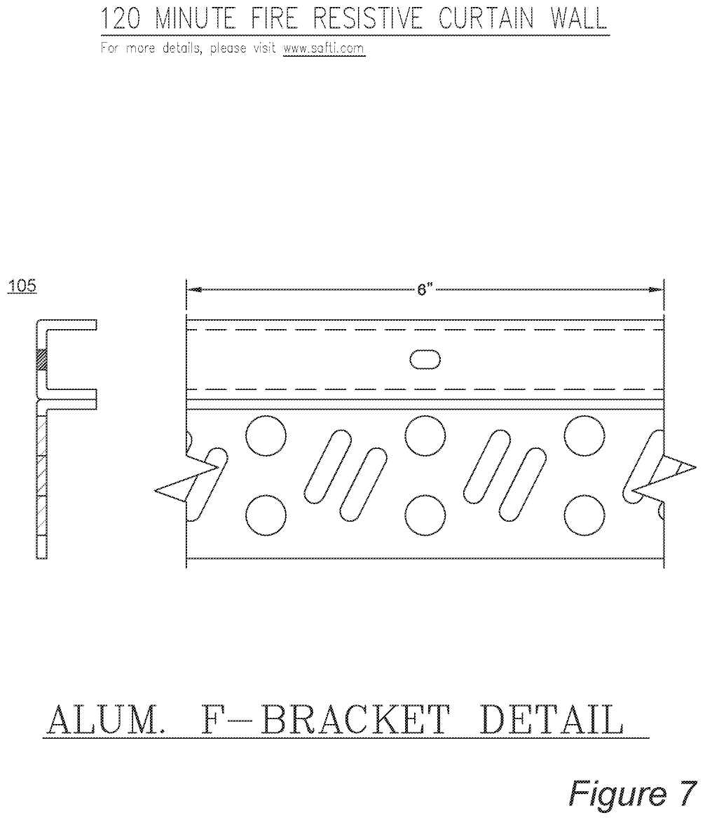

FIGS. 1-8 show an example embodiment with example features, in which the example embodiment is comprised of the following components (corresponding to drawing references numbers, where shown):

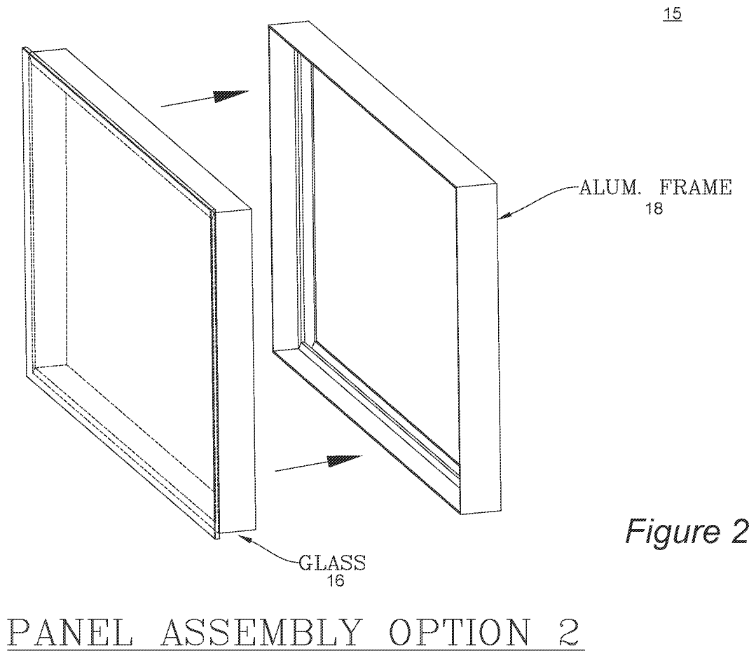

FIGS. 1 and 2 show alternative glass panels 10 and 15 each constructed using a glass sheet 11, 16 inserted into an aluminum frame 12, 18.

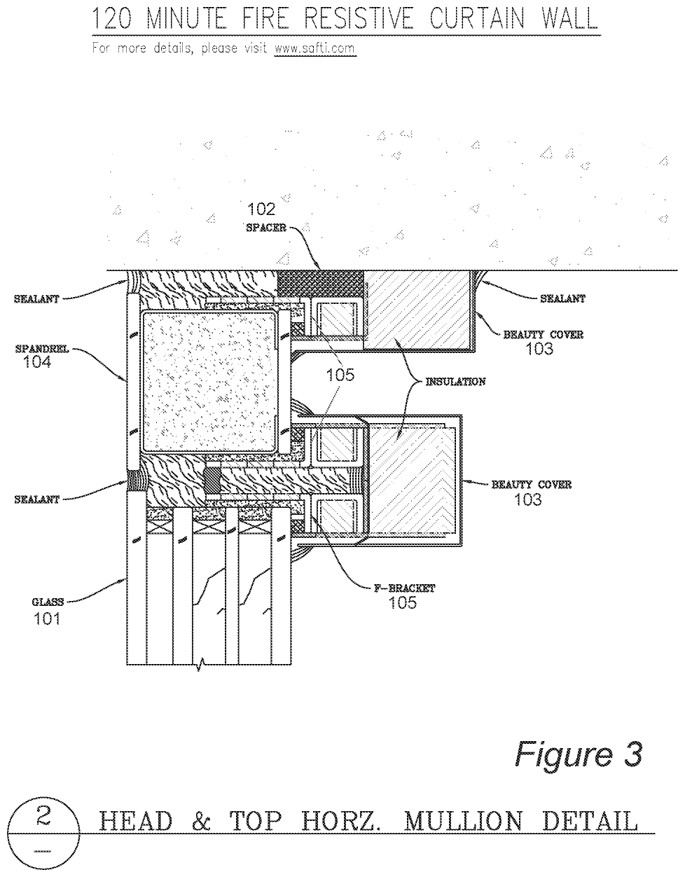

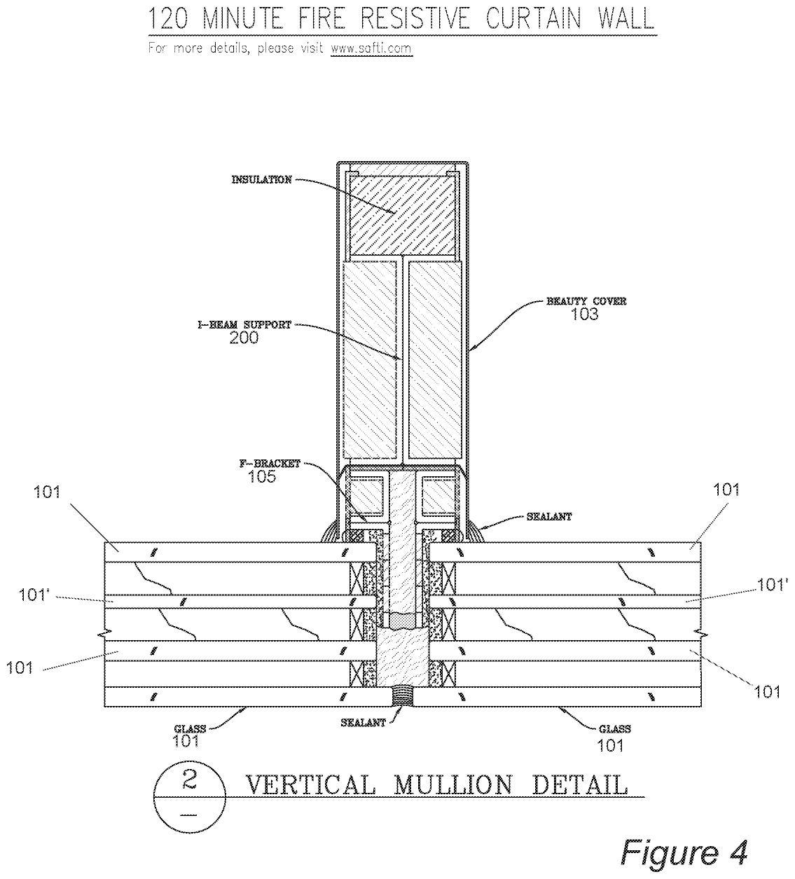

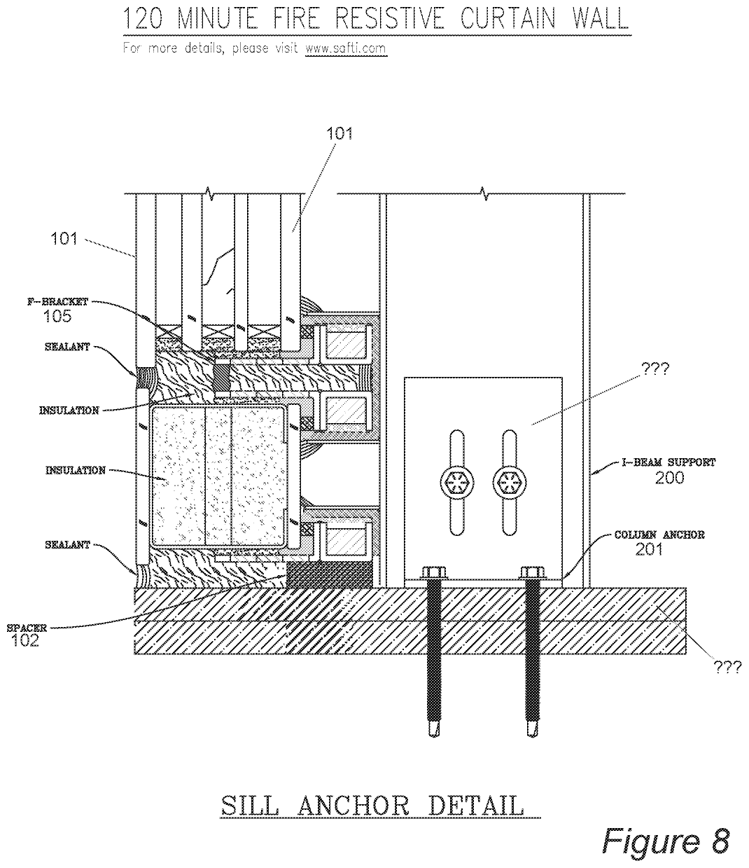

FIGS. 3-6 and 8 show an example wall panel device comprising a plurality of glass panels 101, 101′ (such as the examples shown in FIGS. 1 and 2) which may be fire rated or not, with installation materials including a spacer 102 (e.g., Calcium Silicate board, hardwood or plastic shims), beauty covers 103 (e.g., aluminum or steel), a solid spandrel 104 (e.g., can be of the glass panels, such as describe above), a plurality of F-brackets 105, which can be manufactured remotely in a factory for transport to the installation location. Installation of the wall panel is typically accomplished by mounting on an I-beam (or C-channel) support 200 (as found in the building or other installation location), as shown in FIGS. 4 and 8. The installation is accomplished by mounting the wall panel on the I-beam support 200 (vertical mounting) without, in a typical installation, any mounting horizontally (e.g., no mounting at the floor or ceiling). This mounting is accomplished by connecting the wall panel to the I-beam support using fasteners, along with various spacers, insulation, and sealant to fill cracks and gaps. The I-beam (or C-channel) support 200 along with fasteners 201 can be provided along with the wall panel if no such structure is available in the building for mounting the wall panel.

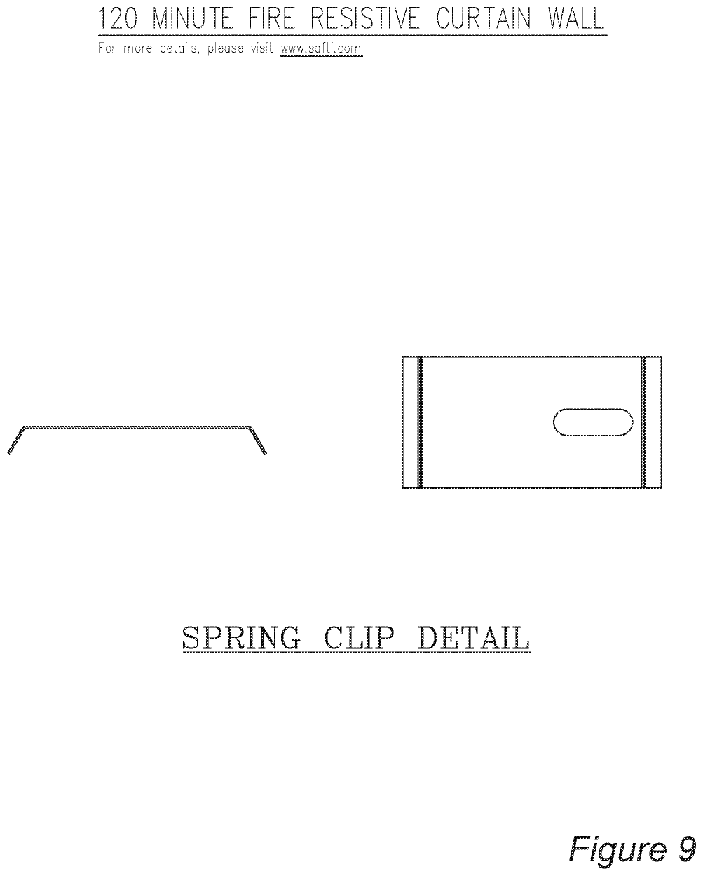

The spring clips as shown in FIG. 9 can be used to fasten or otherwise attached the beauty covers 103. The inner panel 101′ is optional, and can be used to divide up a polymer intumescent chamber for use in fire-rated make-up designs.

Below, additional example features of example embodiments are described:

Fire Resistant Glazing Material:

−3⅛ in. thick glazing units can be supplied in various sizes. Maximum exposed glass size in these examples are not to exceed 72.2 sq. ft (10,400 sq. in.). In at least some embodiments, the maximum exposed glazing height and width can be up to 130 in. Minimum exposed glazing width in this example embodiment can be 27⅝ in. The glazing units can be framed with aluminum channels around the perimeter (see FIGS. 1 and 2). Glazing units adhering to the sizes outlined herein may be installed adjacent to one another with no limitation to the number of panels installed.

For example, 3⅛ in. thick solid spandrels can be supplied in various sizes. Maximum exposed solid spandrel height can be 3⅜ in. with a maximum exposed width of 80 in. Secured to head and sill of opening through spandrel channel, such as with No. 14×3 in spaced 9¼ OC. When the example embodiment is installed in concrete/masonry applications, Masonry Fasteners (e.g., ¼ in×2¾ in Tapcon) can be used at desired spacing, such as spaced at 9¼ inch OC.

For the example embodiment, the glazing units are secured to vertical column, e.g., with ¼ in.×20-1 in. bolts with nuts and washers at top, bottom and center of glazing unit. Then, for example, No. 14×1 in long self-tapping screws spaced 8¾ in OC between bolts can be used for installation.

Glazing units can be secured to spandrels through channels with, for example, No. 12×1¼ in. long self-tapping screws spaced 8¾ in. OC. Glazing units secured to surrounding opening through channels with, for example, No. 14×3 in. long self-tapping screws spaced 8¾ in. OC. When installing in concrete/masonry applications, for example, ¼ in.×2¾ in. Tapcon Masonry Fasteners can be used spaced 8¾ in. OC.

Column Anchors:

The anchor plates used to secure the steel columns into a surrounding opening can be fabricated from ⅛ in. thick CS Type B sheet steel having a minimum yield strength of 30 ksi. Secured to the gypsum opening with six 5/16 in.-12×3 in. long self-tapping screws through each pre-drilled hole. When installing into concrete/masonry applications, four ⅜″×2½″ Large Diameter Tapcon anchors can be used.

Column:

Desired at each vertical joint between glazing panels, e.g., 4 or 6 in. deep, 2 in. wide column (not shown) such as can be fabricated from ⅛ in. thick CS Type B sheet steel having a minimum yield strength of 30 ksi. Alternatively, two c-channels can be formed and joined together to create the column. (E.g., channels fastened together with pairs #12¾ in. TEK screws, centered within column web, spaced 1½ in. apart and spaced 9½ in. OC along the length of the column). When a 6 in. deep column is used, an additional fastener can be spaced 1½ in. away can be installed. The column flanges can have ¼ in. diameter, 1 in. long slotted holes spaced 8¾ in. OC for glazing securement, among other options. Columns can have a 2 in. gap at the top of the opening for expansion.

As an alternate, the column may be fabricated as a single !-section, eliminating column fasteners, so long as it is of the same dimensions and minimum steel strength described above.

Spring Clip:

Spring clips can be installed on column face adjacent to glazing unit channels with, for example, ⅛ in. rivets spaced a maximum of 25½ in. OC. Clips installed over Glazing Tape (Item 10) on channels joining glazing units to spandrels with ⅛ in. rivets spaced a maximum of 18.5 in. OC.

Setting Pads:

For example, 15/32 in. thick board cut to 1⅝ in wide by 2¼ in long pieces and installed adjacent to each fastener can be used to secure spandrel and glazing channels to surrounding wall.

Glazing Tape:

Thick intumescent glazing tape (e.g., 1 in. wide by 2 mm ( 5/64 in.)) with self-adhering backing, adhered over glazing and spandrel unit channels between units and at the perimeter of the assembly.

Ceramic Rope—

A ceramic fiber round braided rope (e.g., ⅝ in. diameter) can be installed over ceramic fiber insulation at joints on the unexposed surface. Two ropes installed into horizontal and vertical glass joints on unexposed side of assembly. On the exposed surface, horizontal joints between glazing and spandrels units also have rope installed over ceramic fiber insulation.

Sealant:

Bead of sealant can be applied over ceramic rope between glazing unit channels and spandrel channels prior to stuffing ceramic fiber from the non-mullion side of the assembly. After space between glazing and spandrel unit channels have been filled, bead of sealant applied at ends of perimeter channels ending at approximately mid-depth of the glazing units. Sealant applied to cover ceramic rope on the unexposed surface. Sealant applied to all joints between beauty caps and adjacent materials,

Channel Trim:

Gypsum strips (e.g., ⅝ by ⅝ in.) notched or drilled to cover fastener heads and adhered within all glazing unit and spandrel perimeter channels with Sealant. Sealant applied on both sides of all fastener locations and at ends of the gypsum strip. Trim pieces may be spliced together to accommodate length such that ends are tightly butted.

Column Web Trim:

Gypsum board (e.g., 1 in. thick) cut to fill entire web of column. Notched or drilled for fasteners and adhered on to each side of the column web with continuous bead of Sealant. Trim pieces may be spliced together to accommodate length such that ends are tightly butted.

Column Face Trim:

SLX type gypsum board (e.g., 1 in. thick) and thick Type C gypsum board (e.g., ½ in.) are cut to a desired width (e.g., 2 in. minimum). The cut gypsum board strips can be laminated together to create a single strip, such as having an overall thickness of 1½ in. The gypsum board strips can be laminated together using Weldwood Contact Cement. Nonflammable Formula by DAP, f or example.

The gypsum strips (e.g., 1½ in. thick by 2 in. wide) can be installed on column face, secured with pairs of No. 12×2 in. long self-tapping screws, centered within column flanges. The pairs of fasteners can be spaced, for example, at a maximum 15 in. OC.

Trim pieces may be spliced together to accommodate length such that ends are tightly butted.

Horizontal Mullion Trim:

Type SLX gypsum board (e.g., 1 in. thick) and Type C gypsum board (e.g., ½ in. thick) can be cut to a minimum width of 2 in. The cut gypsum board strips can be laminated together to create a single strip having an overall thickness of 1½ in. The gypsum board strips can be laminated together using Weldwood Contact Cement, Nonflammable Formula by DAP.

For example, 1½ in. thick by 2 in. wide gypsum strips can be secured to the glazing and spandrel perimeter channels with pairs of No. 12×2 in. long selftapping screws, center within the channel face. The pairs of fasteners can be spaced, for example, at a maximum 14½ in. OC.

Trim pieces may be spliced together to accommodate length such that ends are tightly butted.

Perimeter Trim:

Type SLX gypsum board (e.g., 1 in. thick) and Type C gypsum board (e.g., ½ in. thick) can be cut to, for example, a minimum width of 2 in. The cut gypsum board strips can be laminated together to create a single strip having an overall thickness of 1½ in. The gypsum board strips can be laminated together using Weldwood Contact Cement, Nonflammable Formula by DAP.

Alternatively, ½ in. thick Type C gypsum board and ¼ unclassified gypsum board are cut to a minimum width of 2 in. The cut gypsum board strips are laminated together to create a single strip having an overall thickness of 1½ in. The ½ in. and ¼ in. thick strips can be laminated in the following order: ½ in., ¼ in., ½ in., ¼ in. The gypsum board strips are laminated together using Weldwood Contact Cement, Nonflammable Formula by DAP. When installed, the ¼ in. gypsum board can be installed in contact with the finished opening.

Gypsum strips (e.g., 1½ in. thick by minimum 2 in. wide) can be installed at perimeter of assembly butted up against glazing and spandrel perimeter channels. Gypsum strips secured with No. 10×3½ in. long multi-purpose const ruction screws spaced maximum 15 in. OC.

When installing into concrete/masonry applications, for example, 3/16 in.×2¾ in. PFH 410 Stainless Steel Tapcon fasteners or 3/16 in.×2¾ in. Phillips Flat Head Concrete Anchors Tapcon can be used, for example, spaced maximum 15 in. OC.

Trim pieces may be spliced together to accommodate length such that ends are tightly butted.

Spacer Trim:

Gypsum board spacers (e.g., ¼ in. thick, 2 in. by 2 in.) can be adhered over, for example, 1½ in. thick gypsum board with non-combustible all-purpose adhesive. Spacers can be located under all horizontal joint and column beauty cap fastener locations.

Batts and Blankets: For example, minimum 8 pd ceramic fiber insulation can be stuffed to fill the perimeter of opening between glazing and gypsum lined/concrete opening and to fill the space between all glazing and spandrel unit channels

Joint Compound:

One layer or more of drywall joint compound can be applied over all gypsum board trim prior to installing beauty caps.

Beauty Caps:

Can be installed over the vertical, horizontal and perimeter joints and secured and sealed as described below:

All beauty caps can be cut to ensure tight fit with all mated surfaces. For example, columns: 2½ in. wide, a minimum of 7 3/16 in. deep can be supported. Caps can be secured with No. 8-3 in. long self-tapping drywall screws spaced 16⅞ in. OC. Screws can be located ¾ in. from either side of beauty cap, each screw alternating sides along the length of the column. Over a horizontal channel: As an example, 2½ in. wide, minimum of 3⅛ in. deep, and can be Secured with No. 8×2⅜ in. long self-tapping drywall screws. Spaced 16⅞ in. OC. Screws can be located ¾ in. from either side of beauty cap, each screw alternating sides along the length of the cap.

At perimeter: As an example: 1 9/16 in. wide, minimum 3⅜ in. deep. Secured with No. 10 by 3½ in. long multipurpose construction screws spaced 16⅞ in. OC.

Note that it is preferred that used products should bear the UL or cUL Certification Mark for jurisdictions employing the UL or cUL Certification (e.g., Canada), respectively.

Generally, the wall panels are manufactured in a remote location for transport to the installation location, where they are installed as a unit in a building according to the various features described herein.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of installing a fire rated wall panel at a desired location comprising the steps of:
manufacturing a wall panel comprising a plurality of glass panels configured with one or more mounting components configured as a unit, wherein said wall panel design has been certified to be fire resistant;
transporting the wall panel to the desired location; and
installing the wall panel at the desired location by securely connecting the mounting component(s) to a vertical structure at the desired location without structurally connecting the wall panel to any horizontal structure at a floor or ceiling.

2. A fire rated wall panel comprising:
a plurality of glass panels;
one or more mounting components configured with the plurality of glass panels as a unit, said mounting component(s) being configured to mount to a vertical support structure in a building without need of structurally connecting an upper part or a lower part of the wall panel to any horizontal support structure;
wherein said wall panel design has been certified to be fire resistant, and wherein
said wall panel is configured to be transportable as the unit to the building.
